(19) United States
(12) Patent Application Publication
(10) Pub. No.: US 2007/0031185 A1
(43) Pub. Date: Feb. 8, 2007

(54) Plate-mounted plug-in coupling having three-dimensional compensating movement

(75) Inventors: Andreas Bertram, Herford (DE); Rainer Sussenbach, Steinhagen (DE)

Correspondence Address: SEYFARTH SHAW LLP, 131 S. DEARBORN ST., SUITE2400, CHICAGO, IL, 60603-5803, US

(73) Assignee: Bollhoff Verbindungstechnik GmbH

(21) Appl. No.: 11/474,782

(22) Filed: Jun. 26, 2006

(30) Foreign Application Priority Data
Jul. 20, 2005 (DE) 20 2005 011 420.0

(51) Int. Cl. F16C 11/00

(52) U.S. Cl. 403/122

(57) ABSTRACT

A plug-in coupling for releasably connecting a first structural member and a second structural member comprises a coupling member and a ball stud. The coupling member has a ball socket, a bridging portion, and a sleeve-like retaining portion. The bridging portion 18 is integrally molded to a closed end of the ball socket, and the retaining portion is integrally molded to the bridging portion such that it radially circumscribes the ball socket in spaced relationship thereto and is securable to the first structural member. The ball stud is secured to the second structural member and has a spherical head into which the ball socket can be snapped to lock the plug-in coupling.

### BACKGROUND OF THE INVENTION

The present invention relates to a plug-in coupling for releasably connecting a first structural member and a second structural member as well as a ball socket-like coupling member for this purpose.

Various different embodiments of this type of plug-in coupling which, on the one hand, allow a simple snap connection between the structural members and, on the other, ensure vibration damping between the structural members are known, see for example DE 198 36 108 A1, DE 299 20 379, DE 201 07 949, DE 201 08 408, DE 202 16 836, DE 203 15 778 and DE 20 2004 000 234. They normally consist of a resiliently deformable socket-like coupling member having a ball socket and a ball stud with a spherical head which can be snapped into the coupling socket to lock the plug-in coupling.

In the plug-in coupling of DE 201 08 408, a cylindrical outer wall is integrally molded to the open end of the ball socket having both an annular flange and circumferentially-spaced retaining segments between which the said one structural member is clamped. This allows a “plate-like mounting” of the socket-like coupling member to the first structural member. Vibration-damping relative movements between the two structural members are substantially limited to one direction in this plug-in coupling due to the relatively high rigidity of the socket-like coupling member in the securing area as well as due to the material used.

In the plug-in coupling of DE 202 16 836, a ring-shaped partition wall is integrally molded to the open end of the ball socket, to which a tubular outer wall is in turn integrally molded. The tubular outer wall radially circumscribes the ball socket in spaced relationship thereto and can be inserted into a socket provided for the purpose on the associated structural member. The ring-shaped partition wall of the socket-like coupling member has an undulating profile in longitudinal section, which lends the plug-in coupling a high flexibility not only in the radial but also in the axial direction. The plug-in coupling can therefore realize three-dimensional vibration-damping compensating movements. However, a “plate mounting” is not possible with this plug-in coupling as in the plug-in coupling described above.

### SUMMARY OF THE INVENTION

It is the object of the present invention to provide a plug-in coupling for the releasable connecting of two structural members as well as a socket-like coupling member for this purpose which enables vibration-damping compensating movements between the structural members and which is suited to allow a plate mounting of the socket-like coupling member to the respective structural member.

In the plug-in coupling configured according to the invention, the socket-like coupling member has a bridging portion integrally molded to a closed end of the ball socket which connects the ball socket with a sleeve-like retaining portion. The sleeve-like retaining portion is integrally molded to the bridging portion such that it radially circumscribes the ball socket in spaced relationship thereto and its free end is securable to the first structural member.

The ball socket is to a certain extent movably suspended by means of the retaining portion and the bridging portion such that the ball socket with the spherical head of the ball stud received therein allows three-dimensional vibration-damping compensating movements between the two structural members. At the same time, this constructive solution enables a plate mounting of the socket-like coupling member to the first structural member such that it becomes unnecessary to have an individual socket on the first structural member.

Stiffening ribs are preferably distributed circumferentially in the gap between the ball socket and the sleeve-shaped retaining portion, which advantageously run essentially tangentially to the outer periphery of the ball socket. The stiffening ribs lend the socket-like coupling member a certain rigidity and in particular ensure that the ball socket will reset back into its initial position upon compensating movements between the structural members.

The socket-like coupling member preferably consists of a polyester-based elastomer having good chemical resistance and thermostability. Applicable as materials are above all those with extremely high ultimate elongation, for example on an order of magnitude of 100 to 450%. Other elastically deformable materials are, however, in principle also conceivable.

The invention further relates to a socket-like coupling member for a plug-in coupling as described above.

### BRIEF DESCRIPTION OF THE DRAWINGS

The drawings will be used to describe an exemplary embodiment of the invention in greater detail. Shown is:

FIG. 1 is a longitudinal section through a plug-in coupling configured according to the invention in the mounted state;

FIG. 2 is a perspective view of the plug-in coupling of FIG. 1;

FIG. 3 is a side view of the socket-like coupling member of the plug-in coupling in FIGS. 1 and 2;

FIG. 4 is a view from below of the socket-like coupling member in FIG. 3;

FIG. 5 is a plan view of the socket-like coupling member in FIG. 3;

FIG. 6 is a sectional view in the visual direction of the VI-VI arrow of FIG. 5;

FIG. 7 is a sectional view in the visual direction of the VII-VII arrow of FIG. 5;

FIG. 8 is a perspective view of the socket-like coupling member;

FIG. 9 is a sectional view of a modified embodiment of the socket-like coupling member corresponding to FIG. 6.

### DETAILED DESCRIPTION OF THE DRAWINGS

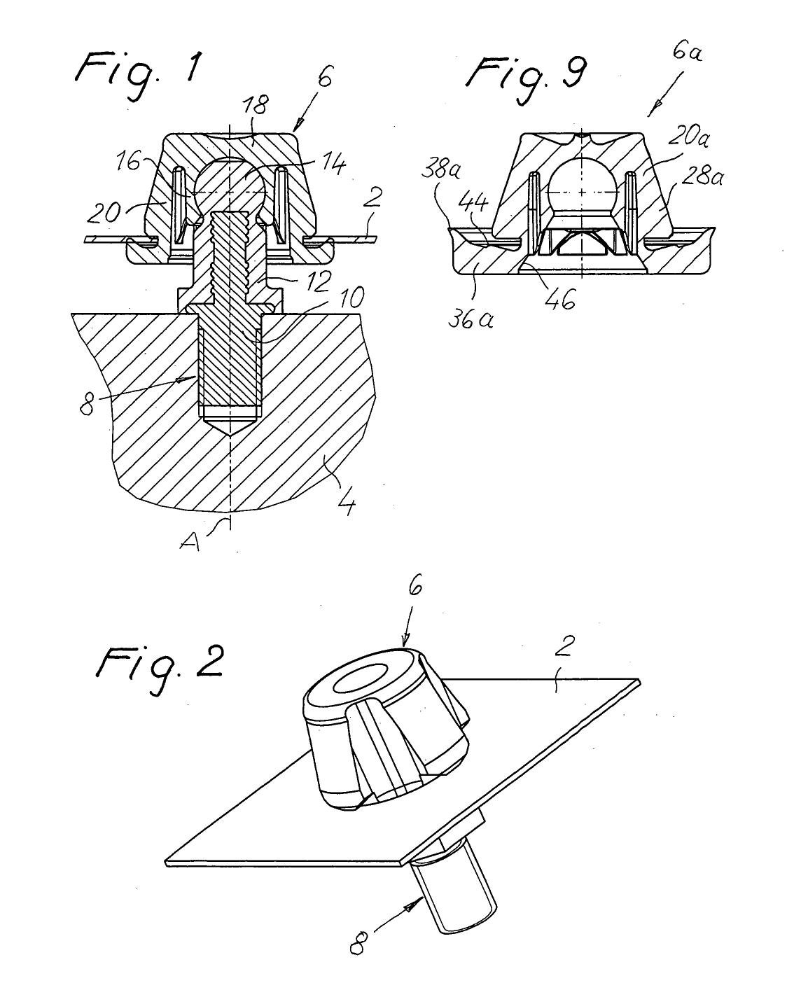

The plug-in coupling shown in FIGS. 1 and 2 serve to releasably connect a structural member 2 and a structural member 4 and can be used, for example, to mount vehicle taillights. The plug-in coupling consists of a socket-like coupling member 6 and a ball stud 8. The socket-like coupling member 6 is secured to structural member 2, which has a plate-shaped configuration at least in the connecting area, and the ball stud 8 is secured to structural member 4.

In the exemplary embodiment as shown, the ball stud 8 consists of a metallic portion 10 and a plastic portion 12. The plastic portion 12 is connected to the metallic part 10 by overmolding of a conical bevel and has a semi-spherical head 14. The metallic part 10 is screwed into a threaded hole of the structural member 4 and thereby secured to the structural member 4. It is pointed out, however, that the ball stud can also be of a different configuration and can be secured to structural member 4 in a different way.

FIGS. 4 to 8 show the socket-like coupling member 6 in detail. Same has a central axis A and consists of a ball socket 16, a bridging portion 18 and a securing portion 20.

The ball socket 16 has a semi-spherical opening 22 which is adapted to the shape of the spherical head 14 such that it can yield a snap-in connection (FIG. 1). It is pointed out, however, that the spherical head 14 of the ball stud 8 and the ball socket 16 can also be of a different form, provided they can be connected to one another by means of only a snap-in or latching connection. A short funnel-shaped insertion portion 24 is connected to the open end of the opening 22 of the ball socket 16 to facilitate the insertion of the spherical head 14 into the ball socket 16.

The bridging portion 18 is integrally molded to the closed end of the ball socket 16 and extends radially outward from there relative to the central axis A. In the exemplary embodiment shown, the bridging portion 18 is of plate-shaped configuration and lies in a radial plane perpendicular to the central axis A. The thickness to the bridging portion 18 is selected in correspondence to the firmness requirements and the desired dimensions for the plug-in coupling.

The securing portion 20 is substantially configured of sleeve or tubular shape and integrally molded to the radial outer wall of the bridging portion 18. It has an essentially cylindrical wall 26 running downward from the radial outer edge of the bridging portion 18 parallel to the central axis A (in FIGS. 6, 7). The bridging portion 18 thereby connects the ball socket 16 and the securing portion 20 in such a manner that the wall 26 of the securing portion 20 radially circumscribes the outer periphery of the ball socket 16 in spaced relationship thereto, an annular gap thus resulting between these two elements.

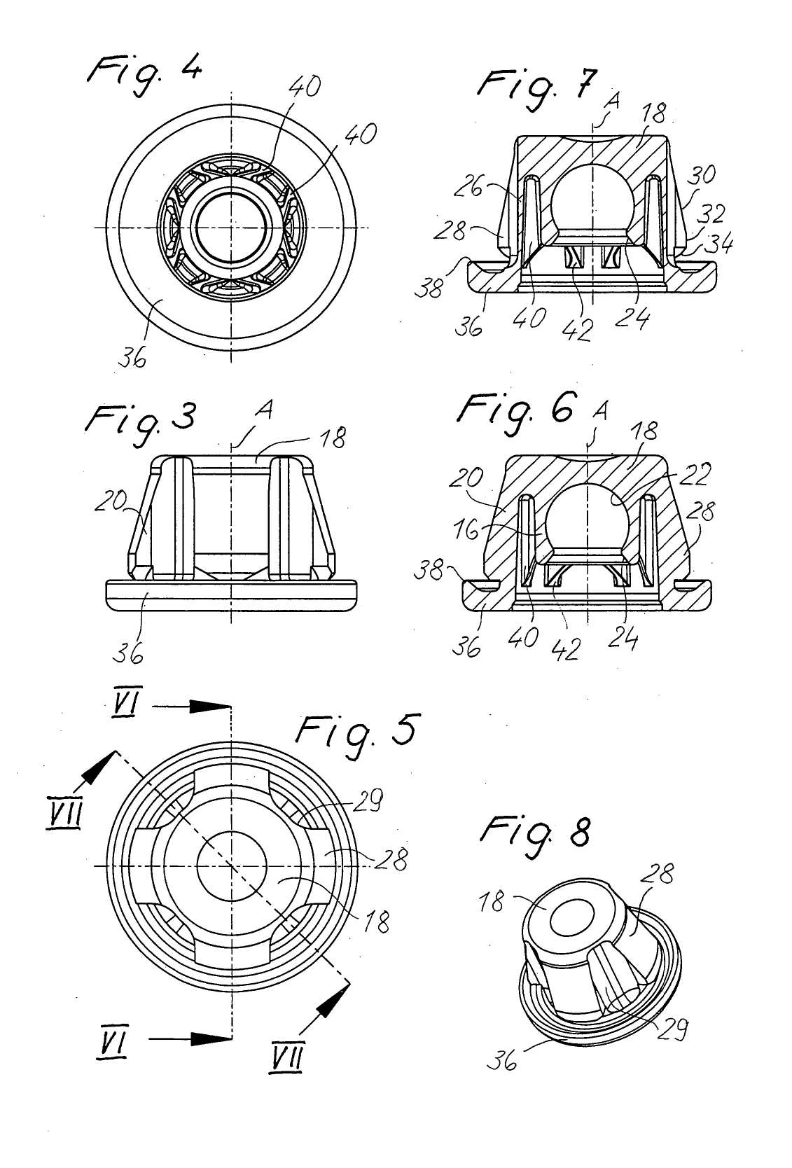

A plurality of radially protruding retaining segments 28 spaced along the periphery are provided on the wall 26 of the securing portion 20, between which are rounded recesses 29, see in particular FIGS. 5 and 8. The retaining segments 28 have sloped outer edges 30 configured as semi-spherical surfaces. Short, semi-cylindrical interfaces 32 are connected to the sloped outer edges 30 which give way to one-way bevels 34, see in particular FIGS. 6 and 7.

The securing portion 20 further has an annular flange 36 coming off of the lower end of the wall 26 (in FIGS. 3, 6, 7). A sealing lip 38 is integrally molded to the radial outer edge of the said annular flange 36. The retaining segments 28 and the annular flange 36 serve to fix the socket-like coupling member 6 to structural member 2 (FIG. 1), as will be described in greater detail below.

A plurality of circumferentially-spaced stiffening ribs 40 are disposed in the gap between the ball socket 16 and the securing portion 20, integrally molded on the one hand to the outer periphery of the ball socket 16 and on the other to the wall 26 of the securing portion 20. As can be seen in FIG. 4 in particular, the stiffening ribs 40 extend essentially tangentially to the outer periphery of the ball socket 16. They are arranged in pairs in such a way that the stiffening ribs of each pair are aligned opposite one another in the circumferential direction. In the exemplary embodiment shown, four rib pairs, i.e., a total of eight stiffening ribs 40, are provided. The rib pairs are arranged on the retaining segments 28 such that one rib pair and one retaining segment 28 are aligned toward one another in the radial direction respectively. There are thus four retaining segments 28 provided in the exemplary embodiment as shown. It is to be understood, however, that a different number of retaining segments 28 and stiffening ribs 40 can also be selected.

As can be seen in FIGS. 6 and 7 in particular, the open end of the ball socket 16 is axially offset inwardly relative the annular flange 36. The stiffening ribs 40 extend axially over the entire axial length of the outer periphery of the ball socket 16 and thus over the entire axial length of the gap between the ball socket 16 and the securing portion 20. The free ends of the stiffening ribs 40 have beveled surfaces 42 (FIGS. 6, 7) which serve as guides when the head 14 of the ball stud 18 is inserted into the ball socket 16.

The socket-like coupling member 6 consists of plastic and preferably a polyester-based elastomer, in particular polybutylene terephthalate (PBT) or polyethylene terephthalate (PET). While these materials are resiliently deformable, they also have a relatively high shear hardness as well as excellent thermostability (150° C. and higher). They moreover exhibit good chemical resistance, in particular resistance to diesel oil. These materials are preferably selected such that they have an extremely high ultimate elongation. The ultimate elongation is generally higher than 100% and, depending upon application, can be on an order of magnitude of from 300 to 450%. However, other plastics such as cross-linked elastomers (for example rubber/caoutchouc) are also conceivable.

In order to secure the socket-like coupling member 6 to the plate-shaped structural member 2, the socket-like coupling member 6 is inserted closed end first into a securing hole of the structural member 2. Since the upper ends of the retaining segments 28 are axially offset somewhat to the upper face surface of the bridging portion 18, there is a short cylindrical area above the said retaining segments 28, the diameter of which essentially corresponds to the diameter of the securing hole of the structural member 2 and which is rounded toward the upper side of the bridging portion 18.

When inserting the retaining portion 20 into the securing hole of the structural member 2, the retaining segments 28 are “folded” radially inwardly. This is made possible on the one hand by the elasticity of the plastic used and on the other hand by the free space between the retaining portion 20 and the ball socket 16. When the retaining segments 28 have been moved through the securing hole of the structural member 2, the bevels 34 of the retaining segments 28 facilitate the centering of the coupling member 6 as well as the rebounding of the retaining segments 28 back into the initial position. The stiffening ribs 40 also support this process.

The structural member 2 is now clamped between the underside of the retaining segment 28 and the sealing lip 38 of the annular flange 36. Since the annular flange 36 with the sealing lip 38 is resiliently deformable, plate-shaped structural members 2 of different thicknesses can be used with socket-like coupling member 6. The thickness of the structural member 2 can vary by an order of magnitude of, for example, 1 to 2 mm.

When the socket-like coupling member 6 is secured to the structural member 2 in the manner described and the ball stud 8 is also fixedly connected to the structural member 4, all that is necessary to lock the plug-in coupling is for the ball stud 8 to be inserted axially into the socket-like coupling member 6 by a relative movement between the structural members 2 and 4 until the head 14 snaps into the ball socket 16. In this state, the plug-in coupling not only provides a releasable connection, but also a vibration damping between the structural members 2 and 4. Since the ball socket 16 is to a certain extent floatingly supported over the bridging portion 18 and the retaining portion 20 and the stiffening ribs 40 run essentially tangentially to the outer periphery of the ball socket 16, the ball socket 16 can realize a radial compensating movement for vibration damping. Axial compensating movements of the socket-like coupling member are mainly enabled by the elasticity of the material used, the ultimate elongation of which, as mentioned above, can be greater than 100% and on an order of magnitude of, for example, 300 to 450%. Due to their recovery from deformation properties, the stiffening ribs 40 also ensure that the ball socket 16 always resets into its central initial position.

In the exemplary embodiment as shown in FIGS. 1 to 8, the socket-like coupling member 6 is dimensioned such that it sits free of play in the securing hole of the structural member 2. The modified exemplary embodiment of FIG. 9 differs from the exemplary embodiment described above in that the socket-like coupling member 6a is arranged to have play in the securing hole of the structural member 2. This allows the plug-in coupling to realize additional compensating movements and furthermore compensate manufacturing tolerances when, for example, a plurality of plug-in couplings are used to connect structural members 2 and 4.

In the exemplary embodiment of FIG. 9, the annular flange 36a is furthermore dimensioned larger than in the exemplary embodiment described above, as is sealing lip 38a. In order to nevertheless obtain a good seal between the socket-like coupling member 6a and the structural member 2, the annular flange 36a is provided with a sealing ring 44 in a radial gap between the sealing lip 38a and the inner circumference of the coupling part 6a. Two or more sealing rings can also be provided instead of just one sealing ring. The retaining segments 28a are further positioned radially farther outward than in the exemplary embodiment described above in order to securely clamp between the retaining segments 28a and the annular flange 36a despite the play to the structural member 2. The annular flange 36a is furthermore provided with a short conical insertion portion 46, as can be seen in FIG. 9, in order to guide and center the ball stud when inserting into the ball socket.

In all other respects, the socket-like coupling member 6a of FIG. 9 corresponds to that as shown in FIGS. 1 to 8.

We claim:

1. A plug-in coupling for releasably connecting a first structural member and a second structural member, comprising
a resiliently deformable socket-like coupling member having a ball socket with a longitudinal axis and having both an open and a closed end, a bridging portion integrally molded to the closed end of the said ball socket, and a sleeve-like retaining portion integrally molded to the said bridging portion such that it radially circumscribes the ball socket in spaced relationship thereto and is securable to the said first structural member, and
a ball stud securable to the said second structural member and having a spherical head into which the ball socket can be snapped to lock the plug-in coupling.

2. A plug-in coupling according to claim 1, characterized in that the bridging portion is substantially of plate-shaped configuration.

3. A plug-in coupling according to claim 1, characterized in that circumferentially-spaced stiffening ribs extend between the ball socket and the retaining portion.

4. A plug-in coupling according to claim 3, characterized in that the stiffening ribs extend substantially tangential to the outer periphery of the ball socket.

5. A plug-in coupling according to claim 4, characterized in that the stiffening ribs are arranged in pairs in such a way that the said stiffening ribs of each pair are aligned opposite one another in the circumferential direction.

6. A plug-in coupling according to claim 1, characterized in that the open end of the ball socket is axially offset inwardly relative the free end of the retaining portion.

7. A plug-in coupling according to claim 3, characterized in that the retaining portion has an annular flange and retaining segments spaced along the periphery, between which the first structural member can be clamped.

8. A plug-in coupling according to claim 7, characterized in that the retaining segments are integrally molded to a substantially cylindrical wall of the retaining portion.

9. A plug-in coupling according to claim 7, characterized in that the retaining segments have sloped outer edges for easier insertion of the socket-like coupling member in a receiving hole of the first structural member.

10. A plug-in coupling according to claim 7, characterized in that the retaining segments have bevels on their axial ends adjacent to the annular flange.

11. A plug-in coupling according to claim 7, characterized in that the retaining segments are equal in number to pairs of said stiffening ribs.

12. A plug-in coupling according to claim 11, characterized in that each retaining segment is allocated to a pair of stiffening ribs in the radial direction.

13. A plug-in coupling according to claim 7, characterized in that the annular flange has a circumferential sealing lip at its outer periphery to abut against the first structural member.

14. A plug-in coupling according to claim 13, characterized in that at least one sealing ring is integrally molded between the sealing lip and the inner periphery of the annular flange to abut against the first structural member.

15. A plug-in coupling according to claim 13, characterized in that the retaining portion has an outer diameter in an area between the retaining segments and the annular flange such that it can be inserted free of play in a securing hole of the first structural member.

16. A plug-in coupling according to claim 13, characterized in that the retaining portion has an outer diameter in an area between the retaining segments and the annular flange such that it can be inserted with play in a securing hole of the first structural member.

17. A plug-in coupling according to claim 1, characterized in that the socket-like coupling member consists of a polyester-based thermoplastic elastomer having good chemical resistance and thermostability.

18. A plug-in coupling according to claim 17, characterized in that the polyester-based elastomer is a polybutylene terephthalate (PBT) or a polyethylene terephthalate (PET).

19. A plug-in coupling according to claim 1, characterized in that the socket-like coupling member consists of a cross-linked elastomer.

20. Socket-like coupling member for a plug-in coupling according to claim 1.
